(19) United States
(12) Patent Application Publication
(10) Pub. No.: US 2026/0169788 A1
(43) Pub. Date: Jun. 18, 2026

(54) Fine-Grained Data Center Orchestration

(71) Applicant: Civarro, Inc., Kirkland, WA (US)

(72) Inventors: Salmeron Barnes, Austin, TX (US); Robert Francis Balsamo, Houston, TX (US); Patrick J.D. Santos, Kirkland, WA (US)

(21) Appl. No.: 19/422,272

(22) Filed: Dec. 16, 2025

Related U.S. Application Data
(60) Provisional application No. 63/735,300, filed on Dec. 17, 2024.

(51) Int. Cl. G06F 9/455

(52) U.S. Cl. CPC G06F 9/45558; G06F 2009/4557

(57) ABSTRACT

Presently, operators of data centers have competing objectives to maximize compute which can be inimical to minimizing energy utilization. Accordingly, there is a need to orchestrate the elements of a data center to balance these competing objectives. Here, a distributor software module automates the dispatching of virtual machine requests to data centers. The requests include characterizations of the workloads to be performed. The dispatcher selects one or more data centers to provide the virtual machine based on the workload characterization. Orchestrator software modules on one or more data centers are equipped with optimization modules. The orchestrators interface with the various data center elements and perform overall optimization and dynamical optimization on a per virtual machine basis. The choice of optimizations may include the balancing of competing objectives. In cases where multiple data centers are utilized, a consensus communications network is employed to provide shared memory for distributed processing.

### CROSS-REFERENCE TO RELATED APPLICATIONS

This application claims priority to a commonly owned, U.S. Provisional Patent Application No. 63/735,300 , filed on Dec. 17, 2025, and titled “Fine-Grained Data Center Energy Orchestration”, which is herein incorporated by reference in its entirety.

### BACKGROUND OF THE INVENTION

Presently, innovations in generative artificial intelligence (GenAI) have driven demand for data center computational bandwidth (referred to hereafter as “compute”). As of this writing, in 2025, data center compute demand is expected to triple globally with a compound annual growth rate, or CAGR, of 22%. More aggressive estimates have ranged as high as quintupling the current compute demand. As a result, the building of new data centers is at an all-time high.

However, another way to meet compute demand is to be able to provide data center compute as efficiently as possible, thereby maximizing the number of customers served with present data centers, since new data centers will take months or even years to come online. However, present compute demand needs present resources. Accordingly, there is a need to optimize the processing of workloads with data center compute.

As data center compute demand increases, so too does the energy demand for these data centers. The New York Times famously reported that with the present proliferation of data center construction, data centers would account for 25% of the electricity demand for the North American Power Grid. To increase energy generation, data center companies are considering private power generation, to the point of proposing sources long considered as non-options, such as nuclear reactors. However, beyond increasing energy generation, the converse approach is to conserve data center energy usage through better power management.

In general, data centers operators are more economically motivated to sell compute, rather than to conserve energy. Data center operators often associate energy conservation as the result of not selling compute services. However, even if a new data center were to come online, it will not be able to service demand if it does not have sufficient energy. Thus, it is as much of a benefit to data centers to optimize energy utilization as to have sufficient energy for compute.

In short, the data center ecosystem has evolved. Compute maximization and energy minimization are objectives that can be, and often are, at odds with each other and need to be balanced. Moreover, present data center infrastructure no longer is limited to a single data center but to a constellation of multiple data centers. In some cases, data centers are geographically disparate. Balancing compute and energy usage, especially in light of balancing these two across remotely located data centers is critical. Accordingly, there is an opportunity to re-imagine data center optimization to maximize compute utilization in balance with power savings over multiple data centers in different jurisdictions through taking advantage of novel information and control architectures.

### BRIEF DESCRIPTION OF DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a context diagram for Fine-Grained Data Center Orchestration.

FIG. 2 is a diagram of an exemplary environment for Fine-Grained Data Center Orchestration.

FIG. 3 is a block diagram for Fine-Grained Data Center Orchestration.

FIG. 4 is a flow chart for Fine-Grained Data Center Orchestration.

FIG. 5 is a block diagram for energy specific Fine-Grained Data Center Orchestration.

FIG. 6 is an expanded block diagram specific Fine-Grained Data Center Orchestration.

FIG. 7 is a flow chart for energy specific Fine-Grained Data Center Orchestration.

FIG. 8 is a block diagram for cross data center compute aggregation in the context of Fine-Grained Data Center Orchestration.

FIG. 9 is a flow chart for the operation of cross data center compute aggregation in the context of Fine-Grained Data Center Orchestration.

### DETAILED DESCRIPTION OF THE INVENTION

### Context for Fine-Grained Data Center Orchestration

Fine-grained data center orchestration involves three different stages. The first stage involves receiving a request from a user for a virtual machine and selecting a data center, or data centers, to provide the compute for the requested virtual machine. The second stage involves configuring and provisioning of the virtual machine at the point of instantiation. The third stage involves monitoring the virtual machine and/or data center during operation and, based on received telemetry, dynamically applying optimizations on the virtual machine and/or the one or more data centers.

During operation, the virtual machine is expected to receive compute workloads to perform. In the case of generative artificial intelligence (GenAI) applications, applications that make use of a language model, such as a Large Language Model (LLM), compute workloads can either be bursty workloads typified for short and intermittent compute demands, or can be steady-state compute workloads typified by a near constant continuous compute demand. GenAI inference is generally bursty and training is generally steady-state. Workloads involving chain of thought and related techniques create sequences of inference in which the output of one inference is input into a subsequent inference. Accordingly, such workloads represent an intermediate workload between bursty and steady-state.

A description of the compute workload mix expected to be performed by a virtual machine is called a workload characterization. Providing a workload characterization assists software providing virtual machines with hints on all three aforementioned stages, i.e., (1) what virtual machine is to be provided, (2) how the virtual machine is to be configured and provisioned, and (3) what optimizations are likely to be applied dynamically. Some users can be expected to provide a workload characterization regarding their request, whereas others may need questionnaires, or may need to be classified with other similar users in order to infer a likely workload characterization.

Once this workload characterization is available, a suitable virtual machine may be instantiated and configured, and subsequent access provided to a user. At this point, the virtual machine and the data center are monitored, and optimizations applied as per some balance of objectives as set by the data center operator.

Automation is key to enabling this balance of objectives. First, data centers receive a large volume of requests for virtual machines, and second data centers have huge number of data center elements. Presently, individual data centers can be expected to have over ten thousand servers. Clearly, manual orchestration is not realistic. Additionally, as data centers and their operations have gotten more sophisticated, optimization tactics have become hyper-specific: they only apply to a narrow and infrequent set of circumstances. Accordingly, and according to aspects of the disclosed subject matter, automation is used to manage a massive library of optimization permutations and configurations, and to recognize when an optimization is relevant and therefore to be applied. In some instances this recognition is performed via an artificial intelligence (AI) algorithm. The AI algorithm may be either a machine learning (ML) application or a GenAI application.

Finally, in accordance with aspects of the disclosed subject matter, data center operators no longer consider individual data centers in isolation. In practice, data center operators not only operate multiple data centers, but they also organize them into constellations, typically though not exclusively organizing geographically proximate sets of data centers. Accordingly, techniques to optimize different data centers such as geoshifting, i.e., shifting of workloads to data centers in jurisdictions with better performance or lower cost, are appearing. According to aspects of the disclosed subject matter, a specific optimization is disclosed herein to aggregate compute resources from different data centers into a single virtual machine.

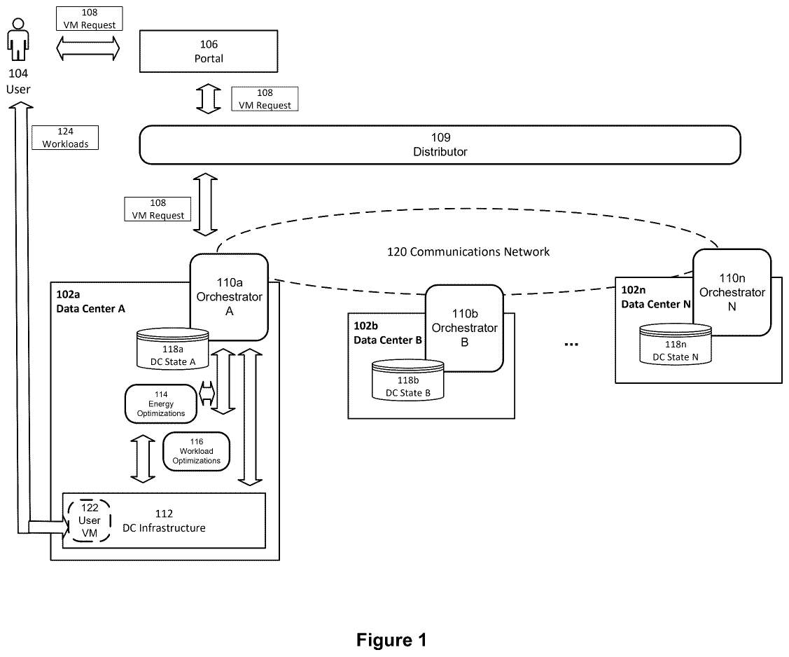

FIG. 1 provides a context diagram 100 for Fine-Grained Data Center Orchestration. Consider a constellation of Data Centers (or DCs) 102a . . . n. A User 104 goes to a web Portal 106 to provide a VM Request 108 for a Virtual Machine (VM).

The VM Request 108 includes, by way of illustration and not limitation, a requested quantity of compute and computer memory resources. It also includes a requested quantity of parallel processing compute resources. Parallel processing compute resources generally include any parallel processing compute cards, such as graphical processing units (GPUs) by way of illustration but not limitation, but can also include cards specifically configured for parallel processing, such as AI processors.

Also, typically (but not necessarily) included with the VM Request 108 is a workload characterization. Depending on the sophistication of User 104, Portal 106 may either simply receive a workload characterization from User 104, or may provide a set of questions and generate a workload characterization, accordingly. In cases where information collected from User 104 is indefinite, Portal 106 may classify User 104 with other similarly situated users, and infer that User's 104 workload characterization is similar to workload characterizations from those similarly situated users. In this way, Portal 106 can ensure a VM Request 108 with a suitable workload characterization.

The Portal 106 forwards the VM Request 108 to Distributor 109. Distributor 109 is a software module that resides in its own virtual machine and is configured to receive registrations from Orchestrators 110a . . . n. According to aspects of the disclosed subject matter, an orchestrator, e.g., any of orchestrators 110a . . . n, is a software module that is installed in a virtual machine in each data center, such as any of Data Centers 102a . . . n. Orchestrator 110a . . . n communicates with Distributor 109 to provide configuration information about their respective Data Center 102a . . . n, and to optimize the Data Center Infrastructure (DC Infrastructure) 112 within the respective Data Center 102a . . . n. DC Infrastructure 112 includes hypervisors, racks, servers, GPUs, EPDUs, or more generally, hardware or software of the DC 102a . . . n that exposes an application programming interface (API) to enable telemetry, automated dynamic configuration, or both. Each Orchestrator 110a . . . n accordingly is in communication with the DC Infrastructure 112 DC elements to collect telemetry.

Each Orchestrator 110a . . . n has access to one or more Energy Optimization software modules (Energy Optimizations) 114, and to one or more Workload Optimization software modules (Workload Optimizations) 116. Energy Optimizations 114 are software modules that implement one or more techniques to, at least, reduce energy utilization, reduce carbon footprint, or otherwise perform some energy related optimization as defined by the data center operator. Similarly, Workload Optimizations 116 are software modules that implement one or more techniques to speed compute performance, enable more users to make use of compute, or otherwise perform some compute related optimization as defined by the data center operator.

The Energy Optimizations 114 and Workload Optimizations 116 each interface to at least some of the exposed APIs of the DC Infrastructure 112. Energy Optimizations 114 and Workload Optimizations 116 implement their respective optimization techniques in terms of these exposed APIs.

Each of Orchestrators 110a . . . n programmatically determines which Optimization 114, 116 to apply based on incoming telemetry. In this way any of Orchestrators 110a . . . n implements a control feedback loop to perform continuous optimization. We note that optimization depends on the objectives of the data center operator. Some data center operators will wish to maximize compute. Others will wish to maximize user density. Yet others will wish to minimize energy consumption. However, in practice, data center operators are generally expected to select objectives that, in fact, represent multiple competing objectives. For example, a data center operator may specify the maximization of revenue. Sometimes, maximizing revenue means maximizing compute when demand is high. However, this can also mean minimizing energy when demand is low and there is compute capacity in excess of demand. In other situations, this can also mean offloading or reselling excess compute. Thus, the Orchestrator's 110a . . . n determination of which Optimizations 114, 116 to apply will change at any moment.

To maintain speed of response with a high volume of requests, Orchestrators 110a . . . n may make use of an AI algorithm, such as an ML algorithm, or alternatively a GenAI application.

Each Orchestrator 110a . . . n may maintain a data store 118a . . . n containing the state of its respective DC. While this DC State data store 118a . . . n may be used for local needs, each DC State 118a . . . n is networked to the other DC States 118a . . . n of each other respective Orchestrator 110a . . . n via a consensus enabled Communications Network 120. Consensus is the computer science term where two networked computers can have a memory store that is guaranteed to have the same values at all times. For example, if Computer A and Computer B are in consensus, they may each have a memory buffer that is configured to be in agreement. If the buffer says “1, 2, 3” for A, it says “1, 2, 3” for B as well. If B changes it to “3, 2, 1” locally, the change propagates to A to say “3, 2, 1” as well. Accordingly, DC States 118a . . . n are always in agreement. Consensus can be implemented with a consensus enabled database such as Couchbase. Alternatively, a blockchain, which often uses consensus to maintain data integrity among nodes, may be used as well.

These consensus shared DC States 118a . . . n are used to coordinate VM's provided by aggregated resources from different DCs 102a . . . n.

Upon selection of a Data Center 102a . . . n to provide a VM for User 104, Distributor 109 will obtain the compute entry points for the APIs for the Data Center 102a . . . n to instantiate a VM from DC's 102a . . . n respective Orchestrator 110a . . . n. Distributor 109 will use those APIs to instantiate User VM 122 In some cases, Distributor 109 will configure User VM 122 at instantiation time by specifying resources to use or by installing optimization software. An example of specifying resources is to make use of a virtual GPU that has been configured to be optimized for particular applications such as GenAI applications. Installation of systems and optimization software may involve the installation of a Parallelism Client software module to help coordinate AI training on aggregated VMs. After configuration and provisioning Distributor 109 will provide the entry point to User 104.

At this point, User 104 may make use of User VM 122 by sending it workloads 124. During operation, the Orchestrator 110a . . . n will dynamically monitor the DC Infrastructure 112, and in near real time deploy Energy Optimizations 114 and Workload Optimizations 116.

In this way, we enable Fine Grained Data Center Orchestration through VM selection, VM configuration and provisioning, and during operation of VM.

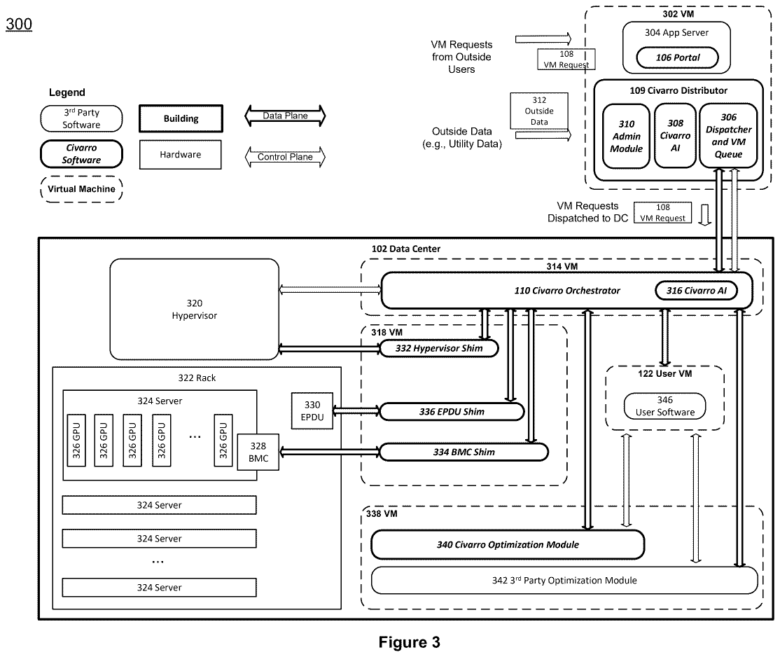

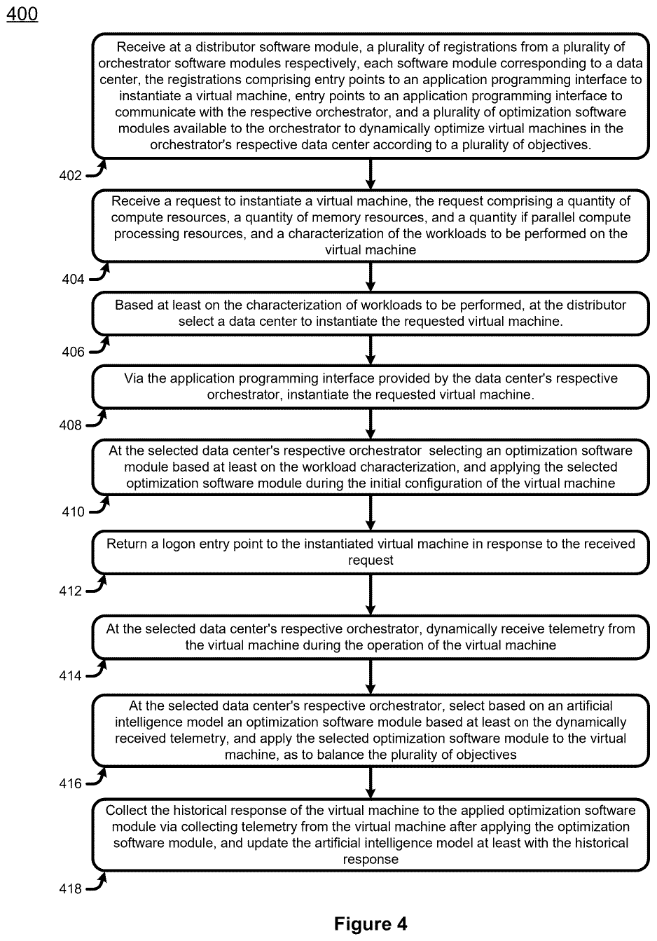

Internals of the interactions of Distributor 109, Orchestrator 110a . . . n, and the data center elements are described in further detail with respect to FIGS. 3-4.

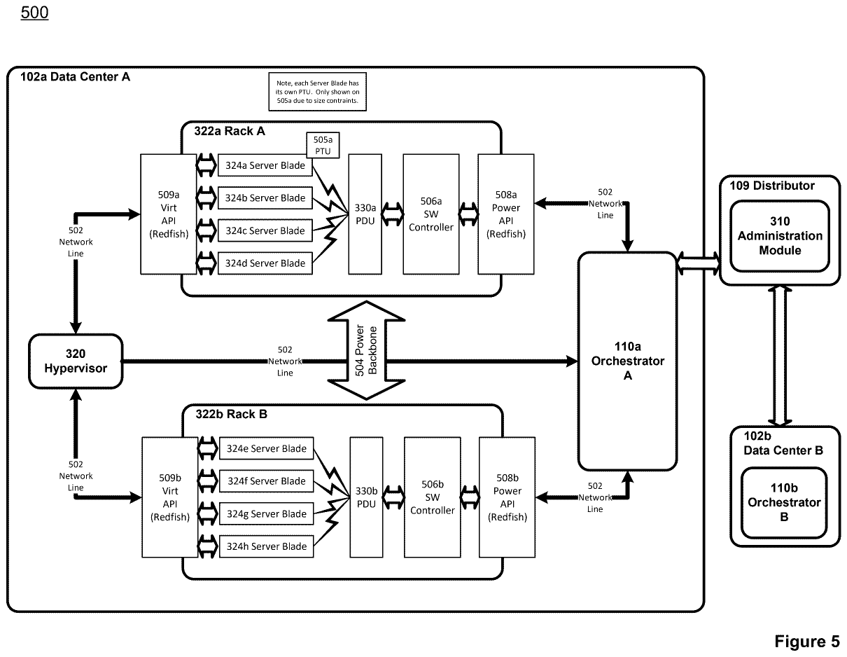

Energy specific optimizations are described in further detail with respect to FIGS. 5-7.

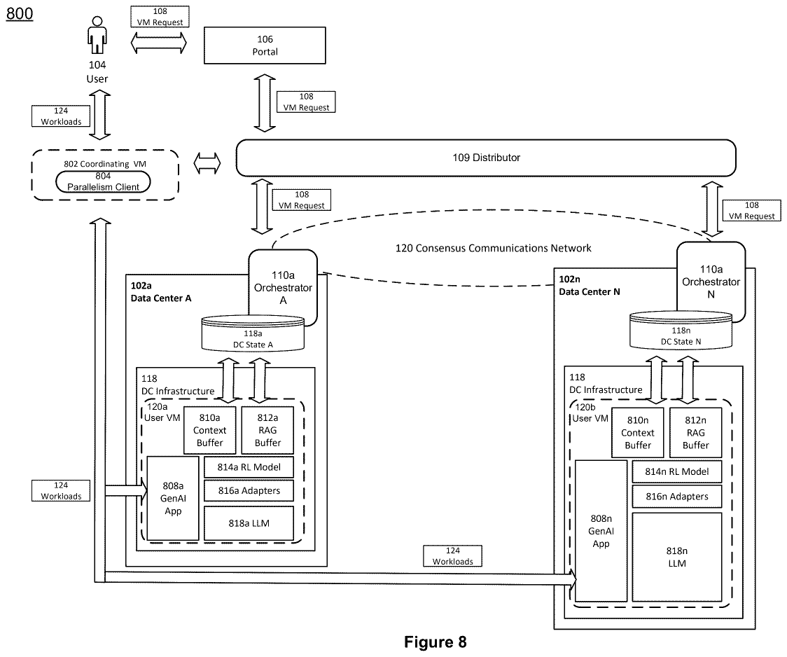

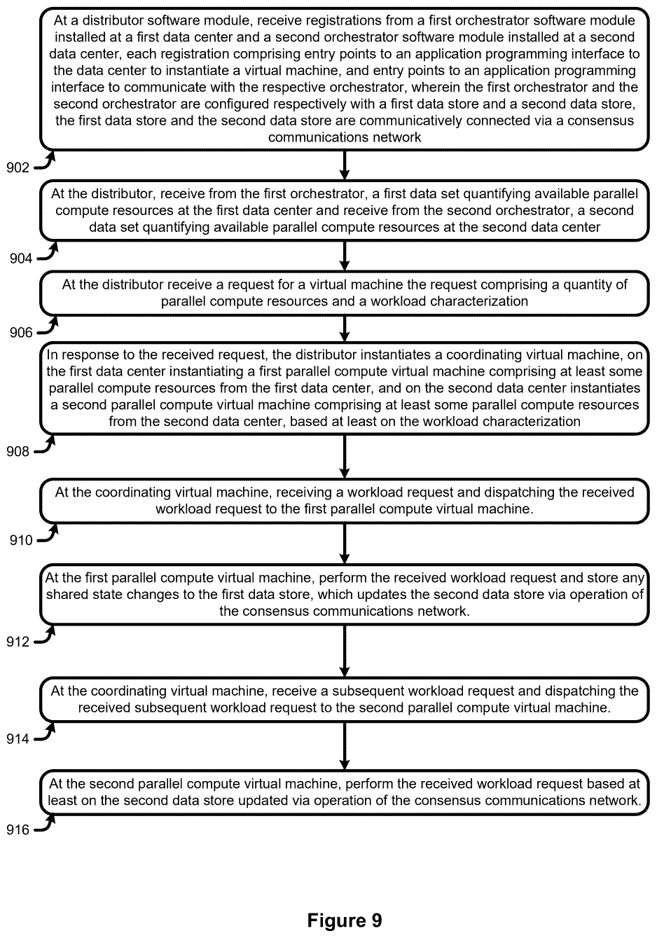

Aggregation of Data Center 110a . . . n resources into a single aggregated VM is described in further detail with respect to FIGS. 8-9.

### Exemplary Environment for Fine-Grained Data Center Orchestration

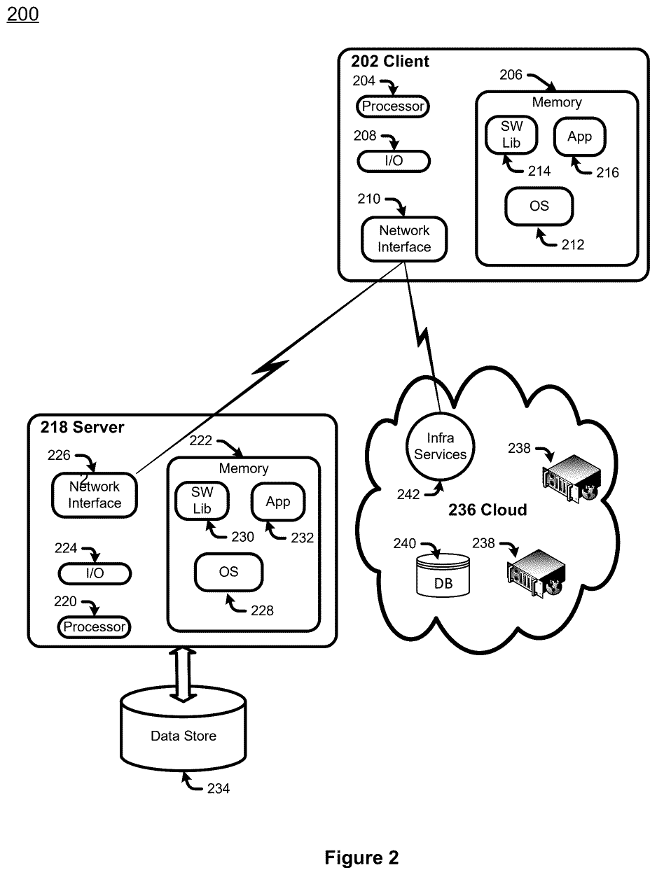

Before describing Fine-Grained Data Center Orchestration in more detail, we describe in FIG. 2 an environment diagram 200 of an exemplary hardware, software, and communications computing environment.

### Client Platforms

The functionality for Fine-Grained Data Center Orchestration is generally hosted on a computing device. Exemplary computing devices include without limitation personal computers, laptops, embedded devices, tablet computers, smart phones, and virtual machines. In many cases, computing devices are to be networked.

One computing device may be a client computing device 202. The client computing device 202 may have a processor 204 and a memory 206. The processor may be a central processing unit, a repurposed graphical processing unit, and/or a dedicated controller such as a microcontroller. The client computing device 202 may further include an input/output (I/O) interface 208, and/or a network interface 210. The I/O interface 208 may be any controller card, such as a universal asynchronous receiver/transmitter (UART) used in conjunction with a standard I/O interface protocol such as RS-232 and/or Universal Serial Bus (USB). The network interface 210 may potentially work in concert with the I/O interface 208 and may be a network interface card supporting Ethernet and/or Wi-Fi and/or any number of other physical and/or datalink protocols.

Memory 206 is any computer-readable media which may store software components including an operating system 212, software libraries 214, and/or software applications 216. In general, a software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes at least two types of computer-readable media, namely computer storage media and communications media. Computer storage media includes volatile and non-volatile, removable, and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

### Server Platforms

A server 218 is any computing device that may participate in a network. The network may be, without limitation, a local area network (“LAN”), a virtual private network (“VPN”), a cellular network, or the Internet. The server 218 is similar to the host computer for the image capture function. Specifically, it will include a processor 220, a memory 222, an input/output interface 224, and/or a network interface 228. In the memory will be an operating system 228, software libraries 230, and server-side applications 232. Server-side applications include file servers and databases including relational databases. Accordingly, server 218 may have a data store 234 comprising one or more hard drives or other persistent storage devices.

### Cloud Service Platforms

A service on cloud 236 may provide the services of a server 218. In general, servers may either be a physical dedicated server or may be embodied in a virtual machine. In the latter case, cloud 236 may represent a plurality of disaggregated servers which provide virtual application server 238 functionality and virtual storage/database 240 functionality. The disaggregated servers are physical computer servers, which may have a processor, a memory, an I/O interface and/or a network interface. The features and variations of the processor, the memory, the I/O interface and the network interface are substantially similar to those described for server 218. Differences may be where the disaggregated servers are optimized for throughput and/or for disaggregation.

Cloud 236 services 238 and 240 may be made accessible via an integrated cloud infrastructure 242. Cloud infrastructure 242 not only provides access to cloud services 238 and 240 but also to billing services and other monetization services. Cloud infrastructure 242 may provide additional service abstractions such as Platform as a Service (“PAAS”), Infrastructure as a Service (“IAAS”), and Software as a Service (“SAAS”).

As stated above, cloud 236 services generally disaggregate physical servers and reaggregate them into virtual machines. This process is accomplished via a software component called a hypervisor. Virtual machines appear to be like a physical server, but because of the disaggregation and reaggregation process, hypervisors enable the efficient use of hardware, as the virtual machine includes only the compute, store, and automation hardware requested, leaving excess hardware capacity to be used in other virtual machines.

Because virtual machines behave like physical servers, the time to boot up the virtual machine may take an unacceptable amount of time. To this end, containerization software such as Google Kubernetes (TM) and Docker, enable partitions of the virtual machine (called containers), to perform compute functions on demand without boot time delay.

### Exemplary Fine-Grained Data Center Orchestration

We are now ready to describe various elements of Fine-Grained Data Center Orchestration in greater detail. FIG. 3 is a block diagram 300 showing internals of Distributor 109, Orchestrator 110 with respect to the Data Center 102 and ecosystem at large. FIG. 4 is a flow chart 400 detailing operation.

Distributor 109 acts as the primary interface to the outside world. It has its own VM 302 which need not be in the same data center as Orchestrator 110. The Distributor's VM 302 has its own App Server 304, such as, by way of illustration and not limitation, an Apache 2.0 app server, to server Portal 106. Portal 106 receives VM Requests 108 and queues it in Dispatcher/VM Queue 306.

Dispatcher/VM Queue 306 selects a VM Request 108 and consults an AI 308 to select a Data Center (or Data Centers) to provide the AI. which may be either implemented via ML or GenAI to determine which of Data Centers 102a...n to select for a particular VM Request 108. Note that the Distributor's 109 AI 308 is not limited to receiving VM Requests 108. It may make use of Outside Data 312 such as weather data and utility data. This can be implemented via external data feeds as published on the internet.

Distributor 109 also includes an Administrative Module 310 that enables configuration of the Distributor 109. Common configurations include registering of Orchestrators 110a . . . n and providing reports. Administrative Module 110 may be accessed via Portal 106 to provide a web interface.

Distributor 109 sends VM Requests 108 to Orchestrator 110. Orchestrator 110 may reside in its own VM 314 in the Data Center 102 that it operates on. In some circumstances the VM 314 may be in a different data center. Orchestrator 110 will run an AI 316 either in the form of an ML algorithm or a GenAI app. AI 316 is used to determine what Optimizations 114, 116 to make use of based in incoming telemetry.

Telemetry is collected on DC Infrastructure 112 through a set of software modules called Shims. These Shims reside in one or more VM's 318 in Data Center 102. The Shim's communicate to at least the following DC Infrastructure 312, as follows, Hypervisor 320, Rack 322, Server 324, Baseboard Management Controller (BMC) 328, and Enclosure Power Distribution Unit (EPDU) 330. Accordingly, specific Shims include Hypervisor Shim 332, BMC Shim 334, and EPDU Shim 336. Each data center element comprising DC Infrastructure 312 exposes APIs specific to that element. Shims 332, 334, 336 are a thin layer of software that provide access to telemetry from those APIs and enable command and control on those data center elements. The Orchestrator 110 is communicatively coupled to the shims to receive telemetry. In some embodiments, Optimizations 114, 116 directly interface with the Shims 332, 334, 336.

It is worth pointing out that with the different types of data in communications, that in some embodiments, the network is subdivided into data planes for the exchange of telemetry and a control plane for exchange of commands. In some embodiments the data plane used by Energy Optimizations 114 is segregated from the data plane used by Workload Optimizations 116. Segregation can be accomplished by making use of multiple network cards, or alternatively by subnetting.

Returning back to FIG. 3, Optimizations 114, 116 also reside in one or more Virtual Machines 338 in Data Center 102. Optimizations 114 and 116 are registered with the Optimizer 110 so that the Optimizer 110 has visibility as to what optimizations are available. Note that some Optimizations 114, 116 may be Native Optimizations 340—optimization software modules made by the same vendor as the vendor making the Orchestrator 110 and Distributor 109. Note that other Optimizations 114, 116 may be Third-Party Optimizations 342. In the case of Third-Party Optimizations 342, extra steps to register with the Orchestrator 110 may be utilized.

At this stage, the Orchestrator 110 has full visibility as to what Optimizations 114, 116 are available and the state of the Data Center 102. When User VM 122 is instantiated, the Orchestrator 110 will be enabled to tell the Distributor 109 and the Hypervisor 320 about configuration options for the User VM 122. For example, if Optimization Module 342 makes virtual GPUs, the Hypervisor 320 (or DC Portal calling the Hypervisor 320) will know that it has an option of making use of the virtual GPUs. Alternatively, the Distributor 109 through Dispatcher 306 may specifically request making use of virtual GPUs. Similarly, User Software 346 such as systems software and optimization software may be installed at the time the User VM 122 is instantiated.

We turn to FIG. 4 to describe via flow chart 400 the operations of Fine-Grained Data Center Operation in further detail. Block 402 describes the initial state of Distributor 109. Specifically, Distributor 109 will receive registrations from one or more Orchestrators 110a . . . n each installed in their own Data Center 102a . . . n. The Orchestrator 110a . . . n registrations include the entry points to create a VM on the respective Data Cetner 102a . . . n. The Orchestrator 110a . . . n registrations also enable programmatic communication between Distributor 109 and the Orchestrator 110a . . . n. Note that at this point, each Orchestrator 110a . . . n has registered Shims 332, 334, 336 and Optimizations 114, 116 and accordingly has visibility to the state of its respective Data Center 102a . . . n and what optimizations are available. We are not ready to receive a VM Request 108.

In Block 404, A VM Request 108 is received by Distributor 109. The VM Request 108 includes compute and memory quantities including parallel compute quantities as well as a workload characterization as described above. In Block 406, this information is processed along with outside information 312 by the Distributor AI 308 to select one or more Data Centers 102a . . . n to host the requested VM. It makes use of information from the Orchestrators 110a . . . n specify to the Data Center 102a . . . n (and its portal and Hypervisor 320) as to what resources should be used for the VM to be made. In this way, the VM will be optimized according to the Distributor 109

In Block 408, the Data Center 102 via Hypervisor 320 instantiates the User Virtual Machine 122. In Block 410, the resources specified by Distributor 109 are utilized and as needed User Software 346 are installed. Again, this is based on the Orchestrator 110 identifying via its AI algorithm 316 that one or more particular Optimizations 314, 316 should be used at VM instantiation time and notifying the Distributor 109. According to the directives of those Optimizations 314, 316, the Distributor 109 will specify to the Data Center 102a . . . n (and its portal and Hypervisor 320) to implement those directives.

Example directives may be to configure User Software 346. User Software 346 may include an operating system and user specified applications. User Software 346 may also include optimization software such as the Parallelism Client. The Parallelism Client is described in further detail with respect to FIGS. 8 and 9. In Block 412, a login and an IP address are returned to User 104.

At this point, the User VM 122 is operational. We are now executing an optimization feedback loop via the Orchestrator 110. The User 104 is now sending Workloads 124 to be performed on the User VM 122.

In Block 414, Orchestrator 110 receives telemetry about the User VM 122 and/or DC Infrastructure 112 from Shims 342, 344, 346. In Block 416, the Orchestrator AI 316 interprets the incoming telemetry and selects one or more Optimizations 114, 116 to apply. Note that the selection of Optimizations 114, 116 to apply with context specific and will change over time. In particular, a data center operator may have competing objectives and accordingly the selection of Optimizations 114 and 116 may represent a balancing of those competing objectives.

Optimizations 114, 116 either send directives to the Orchestrator 110 to invoke calls to the Shims 342, 344, 346 to modulate the DC Infrastructure 112, or alternatively may call the Shims 342, 344, 346 directly. In this way the feedback loop is closed, and operation returns to Block 414.

Note that AI models can be improved with better data. Because the Orchestrator 110 has access to both the telemetry from the Shims 342, 344, 346 and the response of the Optimizations 114, 116, and the results from the subsequent telemetry, the Orchestrator 110 may archive this data. In Block 418, this archived data is subsequently used to train the Orchestrator AI 316 thereby enabling the platform to learn over time.

### Exemplary Energy Optimization for Fine-Grained Data Center Orchestration

At this point, we have described both energy and workload optimization. It is worthwhile to discuss energy optimization specifically.

We first provide some context. Modern data centers typically house 10,000 to 20,000 server blades, each drawing a significant amount of power. These facilities are often clustered within a seven (7) kilometer radius under the control of a single organization. Currently, power distribution to these server blades follows a binary approach: they receive maximum power regardless of their actual needs, or they are powered off. This inflexible system lacks the ability to adjust power draw based on real-time requirements or facilitate energy trading between server blades. As a result, data centers face substantial inefficiencies in both power usage and operational costs. Data centers may hand-tune power utilization but, presently, it is done via hand-tuning (manual scripting) on an ad hoc basis with respect to specific, particular local server racks (i.e., racks of multiple server blades). This inability to dynamically allocate power to individual server blades, or even racks of server blades, based on their current, or at-the-moment needs, leads to unnecessary energy consumption and increased expenses.

Disclosed herein are the software implemented energy features for Orchestrator 110 and related automation infrastructure to perform fine-grained data center energy orchestration. Specifically, an Orchestrator is enabled to apply an algorithmic approach, including utilization of artificial intelligence and generative artificial intelligence (GenAI) approaches, to dynamically tune power utilization on a per server and/or a per virtual machine basis, and while maintaining standards compliance.

Before continuing with a description of the Orchestrator, the following is a description of recent trends in the standardization of energy management. Separate from data centers and industrial controls, the energy industry has developed new architectures to disaggregate and reaggregate energy consumers and producers to create virtualized power plants. Specifically, electric grids are virtualizing energy producers and consumers (called “Distributed Energy Resources”) by adding network and control capabilities. Such network-aware energy producers and consumers are called Integrated Distributed Energy Resources (IDERs). This enables an energy producing resource to be shared and subdivide its power between different energy consumers via software. Conversely, this also enables an energy consumer to receive power from multiple energy providers. Aggregations of IDERs are called Aggregated Data Energy Resources (ADERs) and, where aggregated over a facility for local management, are called “Microgrids.” Advantageously, the disclosed platform, the Orchestrator 110, enables the exchange of power on demand, for example between buildings.

The notion that energy consumption and production can be disaggregated and reaggregated on demand is called “elasticity,” and the reaggregated portions of IDERs and ADERs are known as “virtual power plants.” However, presently, data centers do not take advantage of this standardized approach.

Accordingly, just as data centers presently virtualize computing resources by disaggregating and reaggregating physical computer resources into virtual machines, so power can be managed and virtualized by configuring data centers'compute and power elements into virtual power plants.

Using the notion of virtual power plants, the Orchestrator 110 advantageously enables a data center or cluster of data centers to provide a constituent server blade the exact amount of energy it needs to operate according to current demand. Server blades are equipped with next-generation Power Transaction Units (PTUs) to add network and control functions to the respective server blades. In this way each server blade and its power can be programmatically managed through its respective PTU which turns the server blade into an IDER.

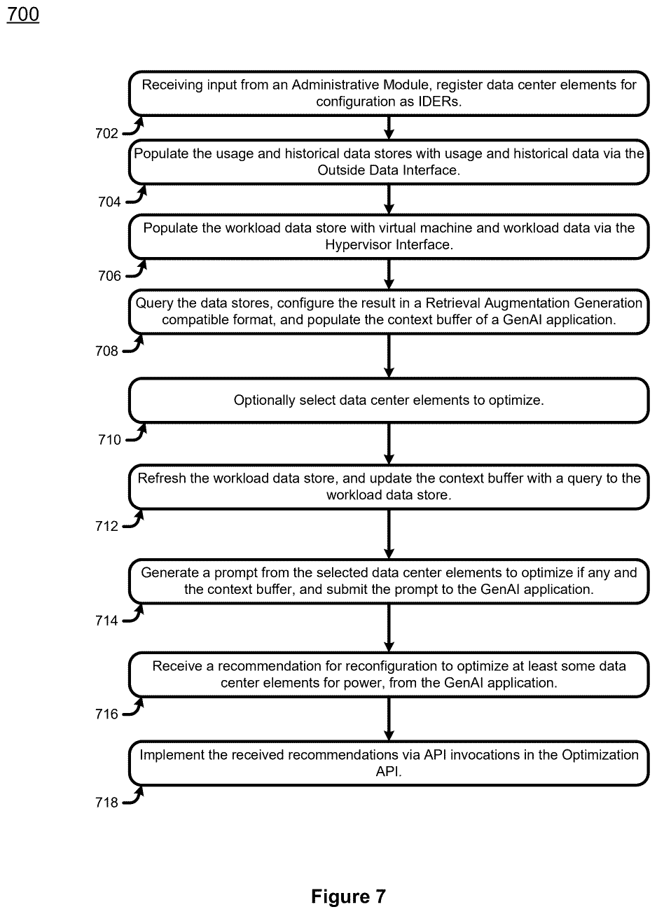

The Orchestrator 110 works in concert with a hypervisor, i.e., a data center system software module that disaggregates physical servers and reaggregates them into virtual machines. With the servers disaggregated and re-organized into virtual machines, the Orchestrator 110, in conjunction with the hypervisor, can determine energy requirements and thereby enable scheduling and trading of energy between server blades, even where the server blades are in different data centers. The Orchestrator 110 can align power physically where power needs are met on a per server basis (called physical centric alignment), or on a per virtual machine basis where virtual power plants are aligned with virtual machines (called virtual centric alignment). The end result is that the Orchestrator 110 and associated techniques drastically make more efficient use of energy and, at the same time, eliminate administration costs. Physical centric alignment and virtual centric alignment is discussed in further detail with respect to FIG. 7.

Because the Orchestrator 110 makes everything look like IDERs, microgrids, and virtual power plants, we can load balance between data centers and, indeed, other power installations on the grid, even those in geographically disparate states (e.g., Texas vs. Washington). Hyperscalers (data center providers making use of multiple data centers in concert) need power load balancing between data centers. Since, without an Orchestrator 110, data centers only control power in each individual data center itself, such cross load balancing between data centers is not presently done. FIGS. 5-7 describe in further detail how energy orchestration is implemented as part of Fine-Grained Data Center Orchestration.

FIG. 5 is a context diagram 500 for fine-grained data center energy orchestration within a data center 102a. Data center 102a contains multiple racks 322a, 322b, each with a plurality of servers 324a-h, depicted in context diagram 500 as server blades. Note that while context diagram 500 shows four (4) servers per rack, in practice there is a wide variance of servers that may be installed per rack.

Servers 324a-h are powered by power backbone 504 via power distribution units (PDU) 330a (for 322a Rack A) and 330 b (for 322b Rack B). As will be seen below, while power backbones are typically at 110V or 220V, data center 102a may make use of higher voltage power backbones.

PDUs 330a, 330b are networked and may support telemetry and remote control. Accordingly, a Server may be configured as an IDER. However, we are seeking even finer grained control, including modulating voltage.

To this end, unlike legacy data centers, servers 324a-h each have their own Power Transaction Unit (PTU). For display purposes, FIG. 5 only includes PTU 505a, corresponding to Server Blade 324a. A Power Transaction Unit, such as one provided by Daanaa, a corporation presently based in Vancouver, Canada, provides individualized power management including voltage conversion and alternating current (AC) to direct current (DC) conversion. Each PTU, e.g., 505a and each PDU 330a and 330b is networked and enables software control to modulate power, including the ability to turn on or shut off power. Additionally, a PTU 505a and/or PDU 330 may provide telemetry to enable data collection. In some embodiments, a Server 324 may only have a PDU 330, or only have a PTU 505a, or may have both. In this way, a Server 324, a PDU 330, a PTU 505a, or some combination of the three, may be instrumented, enabling them to be configured to become an IDER with voltage control.

Note that in configuring data center elements into IDERs, we are configuring a data center 102a, and potentially other data centers, e.g., data center 102b, into a single microgrid. Accordingly, a data center 102a may add power specific resources, such as batteries, and configure those as IDERs, which in turn provide more options to optimize power. For example, instead of throttling power, power may be redirected to battery for utilization afterwards.

In accordance with aspects of the disclosed subject matter, software control is performed by a local software module called a software controller, e.g., software controllers 506a and 506b. While the context diagram 500 depicts one software controller 506 per PDU 330, in practice, each PTU 505a, or some collection of PTUs 505a may have its own respective software controller 506. In some cases, a software controller 506 may control PTU 505a and/or PDU 330 hosted in a location separate from rack 322.

Note that each server 324 will run systems level software, usually in the form of an operating system. Similarly, aggregations of one or more servers in the form of virtual machines will themselves run systems software, also likely in the form of an operating system. In both cases, the systems software may have power management functionality. Accordingly, it is contemplated that the software controller 506 will interface with either server 324 systems level software, and/or with virtual machine systems level software to perform power management orchestration. Both a physical server 324 and a virtual machine are expected to be networked each with their own network address. The software controller will network with the physical server 324 and/or virtual machine to enable access to their respective power control APIs.

Rack automation is generally performed via invoking an application programming interface (API) which in turn makes calls to on-rack software and device drivers. A standard API to do so is Redfish, but alternative APIs exist and custom alternative APIs may also be implemented instead. In context diagram 500, each Rack 322 has a Power API 508, e.g., Power APIs 508a and 508b, to interface with a corresponding software controller 506 and a virtualization API 509 to enable disaggregation of servers 106.

Power API 508 and Virtualization API 509 are depicted separately in context diagram 500 in order to emphasize that virtual machines, through virtualization API 509, and virtual power plants, created from power API 508, are separate and can be configured either to match each other in parallel, or may be alternatively configured. In other words, just as virtual machines can be reaggregated arbitrarily from elements of physical servers, virtual power plants can be reaggregated from contributions and power utilizations from different physical servers.

To this end virtual machines are created via hypervisor 320 invoking virtualization API 509 over network 502. Similarly, virtual power plants are created on Data Center A 102a, via Orchestrator 110a, also over network 502. Hypervisor 320 and Orchestrator 110a are also communicatively coupled over network 502. As will be seen below, Orchestrator 110a makes use of a virtual machine configuration and workload information managed by hypervisor 116 to determine how to configure virtual power plants. This information transfer is affected via the networking together of hypervisor 320 and Orchestrator 110a over network 502.

As stated above, Orchestrator 110 creates IDERs out of individual servers 324, PTUs 505a, PDUs 330, and virtual machines or collections thereof. Those IDERs can in turn be aggregated into ADERs and ultimately into virtual power plants. An Orchestrator 110 is not necessarily restricted to just one such as Data Center A 102a but can interface with other IDERs in other data centers such as Data Center B 102b via Distributor 109. In one embodiment, an Orchestrator 110a for Data Center A 102a coordinates with an Orchestrator 110b for Data Center B 102b. While, in other embodiments, Orchestrator 110a may interface for management via Distributor 109 other Data Center servers 324 or IDERs, in practice, it is useful to have one Orchestrator 110 per Data Center 102 as there is generally less network latency within a data center than between data centers, thereby making reconfiguration and control of IDERs more responsive.

Distributor 109 is configured via Administration Module 310. Administration Module 310 is a software application that interfaces directly with Distributor 109 and Orchestrators 110a . . . n and may be in the form of a desktop application, a mobile application, or a web page. Among its functions, Administration Module 310 is used to add/remove devices such as servers 324, register PTUs 505a and PDUs 330, create IDERs, aggregate into virtual power plants, set optimization algorithms, and interface with other Orchestrators 110b.

In sum, the above described infrastructure provides fine grained control of data centers at the per server and per virtual machine level, including the modulation of voltage, and can abstract IDERs into virtual power plants.

### Higher Voltage Energy Bus for Data Centers

Recall that in FIG. 5, context diagram 500 shows the power backbone 504 for data center 102. Typically, power backbones are configured to be 110V or 120V. However, as data centers 102 generally have a large number of devices, i.e., servers, which have uniform power demands. Accordingly, data centers are free to use a power backbone voltage of choice. To this end, power backbone 504 may in practice be a higher voltage such as 400V or 800V. Higher voltage power backbones 504 have less power loss in stepping down voltage and in power conversion. Because of the enormous power utilization of data centers, the prevention of even a small percentage of power loss can result in considerable power and operational cost savings.

Control System for Fine-Grained Data Center Energy Orchestration

Fine-grained data center energy orchestration involves three sets of functionality: (1) fine-grained control, (2) abstraction of elements of data centers (such as Servers 324, PTUs 505a, PDUs 330, virtual machines, or collections thereof) into IDERS and virtual power plants, and (3) orchestrating power utilization.

Fine-grained control is effected via enabling interfaces not only to PDU 330 and/or PTU 505a, but also with each physical server 324 and each virtual machine. Accordingly, a software controller 506 has visibility and control with every parameter exposed through hardware or software.

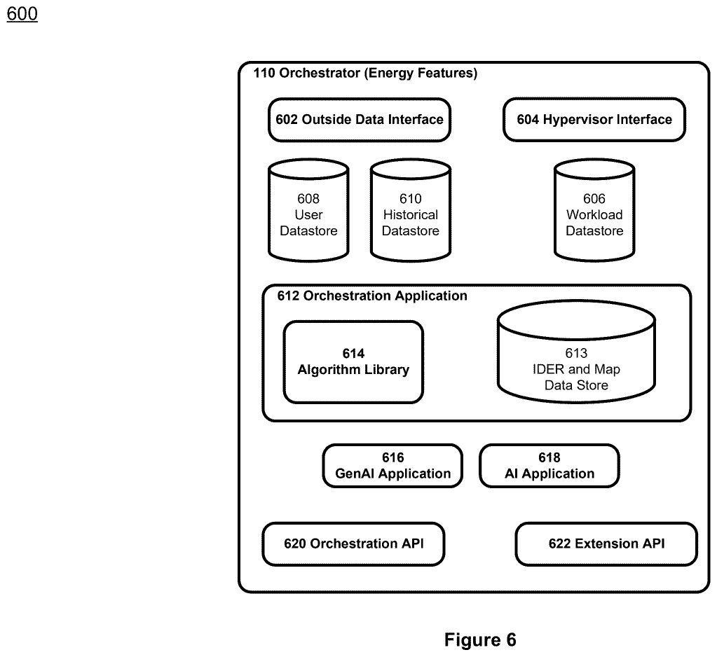

Abstraction and orchestration are effected via Orchestrator 110. FIG. 6 is a block diagram 600 of an exemplary Orchestrator 110 from an energy specific perspective. Note that other workload optimization features are omitted for purposes of this Figure. Orchestrator 110 collects information about power utilization, both in real-time and from historical data. It applies one or more analysis algorithms and develops a dynamically changing orchestration course of action. The course of action is then effected via software calls to the various data center elements. This process is described in greater detail with respect to FIG. 7.

Orchestrator 110 interfaces with the outside world through outside data interface 602 and hypervisor interface 604. Both interfaces 602, 604 are software modules that make calls to outside data source APIs and hypervisor APIs respectively.

Outside data interface 602 collects usage profile information on a per user basis, such as determining typical workload patterns, and stores it in user datastore 608. In some embodiments, usage data is anonymized and keyed to an identifier that cannot be traced to the personal identity of the user. Outside data interface 604 also receives historical usage patterns, often by use case to show likely power utilization for that use case. For example, the power utilization of showing a video is different from the power utilization of a word processor which is less processor intensive than that of the video. Some use cases have peaks and valley of power demand where others have a steady power demand profile. Historical data is stored in historical data store 608. The importation and management of usage and historical data is managed via administration module 310.

Hypervisor interface 602 interfaces with hypervisor 320 to receive virtual machine configuration information and workload configuration information. Specifically, users specify the configuration of virtual machines and workload utilization to hypervisors. Hypervisors can then be invoked by the Orchestrator 110 to obtain near real-time configuration and workload information which is then through hypervisor interface 604, which in turn is stored in workload datastore 606.

The information collected in user datastore 608, and historical datastore 610 means that the Orchestrator 110 has visibility on likely power demand profiles based on user and use cases. The information collected from workload datastore 606 means that the Orchestrator 110 has visibility as to what a virtual machine is doing or about to do. This enables the Orchestrator 110 to have an improved predictive capability with respect to likely power utilization and thereby orchestrate power usage for cost and power savings. This orchestration logic is performed by orchestration application 612.

Orchestration application 612 comprises an IDER and Map data store 613 and an algorithm library 614. IDER and Map data store 613 contain the definitions of power consuming IDERs in terms of aggregations of physical servers 324, PTUs 505a, PDUs 330, virtual machines themselves, and potentially other power specific resources such as batteries, and the mapping of power sources usually in the form of reaggregated PDUs 330 to the power consuming IDERs. The configuration of IDERs and the mapping of IDERs is performed via Administrative Module 310.

It should be appreciated that IDERs generally are configured as power consumers, power producers, or a combination thereof. Note that strictly speaking, a PDU 330 is not a power producer, but rather forwards power from the power backbone 504. However, for purposes of abstraction, a PDU 330 can be treated as a power producer and, accordingly, we refer to it instead as a power source.

The algorithm library 614 contains a preloaded set of optimization algorithms. Orchestration application 612 interfaces with a generative artificial intelligence (GenAI) application 616 which can perform predictions as to energy utilization and provide recommendations of power configuration to optimization power savings. Orchestration application 612 also may interface with a standard machine learning/artificial intelligence predictive model separate from the GenAI application 618.

Note that a GenAI application 618 is comprised of a large language model (LLM), a context buffer, a reward model, and an LLM agent. The orchestration application 612 can populate the context buffer with usage data and historical data. The LLM agent then treats real time workload information as the basis for a prompt. The LLM and reward model then have the necessary inputs to make the orchestration predictions and recommendations.

Orchestration application 612 then implements the generated recommendations via invocation of the Orchestration API 620 which, in turn, invokes Power API 508 and/or various power APIs exposed by server systems software and/or virtual machine systems software.

The Orchestrator 110 in general can be automated remotely, or have data queried via Extension API 622. In practice, the Administrative Module 310 interfaces with the Orchestrator 110 through this Extension API 622.

Adaptive Fine-Grained Data Center Energy Orchestration

As mentioned above, fine-grained data center energy orchestration enables the arbitrary disaggregation of data center elements such as servers 324, PTUs 505a, PDUs 330, virtual machines and potentially batteries as independent IDERs and the IDERs arbitrarily reaggregated into virtual power plants. Orchestration can take two approaches. One is physical centric alignment where a physical server 324 and potentially its PTU 505a is configured to be an IDER focused on power consumption, and one or more PDUs 330 and potentially one or more batteries are configured to be an IDER focused on serving power. Orchestration is then an exercise of mapping power source IDERs to physical servers 324 in the form of power consumption IDERs and modulating the power source IDER or IDERs.

The other is virtual centric alignment where a virtual machine is configured as a power consumption IDER. Orchestration here is then instead an exercise of mapping virtual machine IDERs to power source IDERs. FIG. 7 is a flow chart 700 describing the process of orchestrating IDERs.

First, one or more IDERs are configured. In block 702, input is received from the Administrative Module 310 to register the physical elements of a data center 102. These include physical servers 324, PTUs 505a, and PDUs 330. These devices are stored in the IDER and Map Data Store 613 for future mapping.

In block 704, the Orchestrator 110 queries usage information and historical data from outside sources using outside data interface 602 and queries the hypervisor for virtual machine and workload data through hypervisor interface 604. Usage data, historical data, and virtual machine/workload data are stored in user datastore 608, historical datastore 610, and workload datastore 606 respectively.

In block 606, Orchestrator 110 enlists in events with respect to the hypervisor 320. Whenever a virtual machine is created and destroyed, the Orchestrator 110 receives a software notification and updates the list of virtual machines active. This information on virtual machines is stored in both the workload data store 606 and the IDER and Map Data Store 613. In this way a user has visibility as to what virtual machines can be turned into IDERs.

In block 708, the Orchestrator 110 configures itself with usage data from user datastore 608, and historical datastore 610. The orchestration application 612 creates a query of the user and historical datastores 608, 610, formats the received data, and then loads the context buffer of the GenAI application 616 using Retrieval Augmentation Generation techniques. This provides the means to bias the LLM and reward model for power optimization.

We are now ready to optimize. In block 710 input is optionally received from the Administrative Module 310 which allows a user to select physical servers 324, PTUs 505A, PDUs 330, and virtual machines are to be optimized. If selected, this information is used as part of preparing a GenAI prompt.

In block 712, the orchestration application 612 periodically updates IDER mappings and power settings of PTUs 505a, PDUs 330, and virtual machines. Alternatively, the orchestration application 612 may enlist in software events that trigger a reconfiguration. During a reconfiguration, the workload datastore 606 updates, and the orchestration application 612 queries the workload datastore 606 for the current state of workloads and configures the received information in concert with the context buffer, appropriate for a GenAI prompt.

In block 714, the GenAI application 616 configures a prompt and submits it to the Gen AI application's LLM agent. Recall that the context buffer has been prepopulated with usage and historical data from block 604. Furthermore, note that the context buffer has been populated with virtual machine information and workflow information in block 608. Accordingly, if optimization is to be virtual centric, the context buffer will be aware of what virtual machines are to be optimized.

In block 716, the GenAI application 616 generates a recommendation, and the LLM agent of the GenAI application 616 filters recommendation results for accuracy and suitability.

Finally in block 718, the recommendation results are implemented by the orchestration application by calling the orchestration API 620 to reconfigure the IDERs and to update the IDER and Map datastore 613 accordingly. This process is performed repeatedly.

Use Cases for Fine-Grained Data Center Energy Orchestration

The aforementioned infrastructure is suitable for configuring data centers for power optimization and power and cost savings compared to prior art data center power management techniques. At a minimum, use of a high voltage power bus 504 and use of voltage modulation will result in less power transmission and conversion losses. However, converting data center elements (such as servers 324, PTUs 505a, PDUs 330, and virtual machines) into IDERs and performing physical-centric and virtual-centric optimization will also yield savings as well. The following are some use cases of Orchestrator 110 and its associated infrastructure.

A first use case is predictive based optimization. Because the Orchestrator 110 stores usage and historical (use case) data and populates a GenAI context buffer, the Orchestrator 110 is able to predict future utilization of power on a per IDER basis. Note that the prediction need not be in the far future, but simply needs to be accurate enough to be correct for the next Orchestrator 110 reconfiguration cycle. As the GenAI application 616 collects more information, it gets more accurate and the possibility for better power savings increases.

A second use case is around intra-data center power optimization. Specifically, excess power can be routed to batteries, or otherwise power redirected to other power consumption IDERs. Otherwise, IDERs such as virtual machines and physical servers can be throttled to use less power when lower workloads are expected. In this way, power load balancing can be performed.

A third use case is inter-data center power optimization. Recall, that multiple data centers have their own Orchestrator 110. The Orchestrators 110a . . . n can then perform load balancing between data centers. Specifically, just as utilization can be throttled based on knowledge of workload, power can be sent to battery or otherwise redirected to other data centers. Note also that since a data center is configured as a microgrid, the Orchestrator 110 can load balance with other microgrids on the national power grid, such as other campuses or buildings.

Exemplary Process for Cross Data Center Compute Aggregation in the Context of Fine-Grained Data Center Orchestration

As described above with respect to FIG. 1, one optimization is to make use of resources from different data centers, aggregate these resources into a single VM, for use by a user. The difference between aggregating resources within a data center with a hypervisor and aggregating resources between data centers is the speed of the network connection. First of all, network connections between data centers are much slower than a network connection between adjacent servers on the same high speed Local Area Network (LAN). Second, distributed computing generally means the sharing of state which sometimes is too large to be timely shared. Finally external network connections such as connections between data centers are not as reliable. External factors such as cut lines and bad weather can impact network connectivity.

Accordingly, the focus on aggregating compute across data centers is on lowering dependency on the network. This means replicating what can be replicated and reducing state sharing as much as possible. How this is done depends on use case. Because much growth of data center operations is around GenAI, we focus on optimizing for inference use case and we optimize for AI model training cases. Specifically, we implement a consensus mechanism to share state and reduce the amount of sharing to a minimum.

FIG. 8 is a block diagram 800 illustrating Cross Data Center Compute Aggregation. FIG. 9 is a flow chart 900 describing the operation.

In FIG. 8, User 104 accesses Distributor 109 via Portal 106 as described with respect to FIGS. 1 and 3. However, here the VM Request 108 specifies that the User 104 is willing to accept an Aggregated VM, which is a virtual machine made up of compute resources from multiple data centers. The Aggregated VM 802 is a VM with minimal requirements that coordinates resources from other Data Centers 102a . . . n.

Aggregated VM 802 is returned from a DC 102a . . . n as an ordinary VM but it is configured with a Parallelism Client 804 which is a software module that orchestrates inference workloads and AI model training workloads. The operation of Parallelism Client 804 is described in further detail with respect to FIG. 9.

When the Aggregated VM 802 is created, Distributor 109 works with Orchestrator 110a . . . n to identify available compute. It then creates User VMs 120a . . . n and returns references to Parallelism Client 804.

In the case of receiving an inference workload 124, the User's 104 GenAI application is replicated across the different User VM's 120a . . . n. Specifically, a GenAI App 808a . . . n, a Context Buffer 810a . . . n, Retrieval Augmented Generation (RAG) buffer 812a . . . n, Reinforcement Learning Model (RL Model) 814a . . . n, Adapters 816a . . . n, and Language Models 818a . . . n have local copies on each User VM 120a . . . n.

While the GenAI App 808, RL Model, Adapter 816, and Language Model 818 doesn't change while running, the Context Buffer 810a . . . n and RAG Buffer 812a . . . n do. Recall that Orchestrator 110a . . . n is communicatively connected via Consensus Communications Network 120 to the other Orchestrators 110a . . . n. Specifically, each Orchestrator 110a . . . n has a DC State 118a . . . n data store that is kept in consensus with each other via Consensus Communications Network 120. Accordingly, changes to the Context Buffer 810a . . . n and the RAG Buffer are reflected to the DC State 118a . . . n which in turn is propagated via consensus to the other DC State 118a . . . n data stores. Those changes are then reflected back into the local Context Buffer 810a . . . n and RAG Buffer 812a . . . n. If the GenAI app 808 is accessed for subsequent work on a different User VM 120a . . . n the correct state in the Context Buffer 810a . . . n and RAG Buffer 812a . . . n will be accessible.

There are still network overhead and latency in managing consensus. Accordingly, it is worthwhile to minimize consensus updated. In some cases, inference workloads 124 are independent. In this case, inference workloads 124 can be dispatched without regard to the data center 102a . . . n the underlying User VM 120a . . . n is located. In some cases, inferences, such as chain of thought inferences, are not independent and it is worthwhile to batch those inferences in sequence, and to dispatch those sequences as a single workload 124 to a User VM 120a . . . n. The Parallelism Client 804 may track these inferences as partially ordered sets (posets) encoded as a graph, i.e., a poset graph. By traversing the poset graph, the Parallelism Client 804 will be able to select batched sequences and dispatch to a User VM 120a . . . n in a single workload 124.

In the case of receiving a training workload 124, training is known as an “embarrassingly parallel” problem, which is a computer science term for a problem that can be easily solved with parallel processing. Training workloads can be subdivided, processed in parallel, and then the results are joined together. Training workload subdivision can come in the form of data parallelism, model parallelism, and pipeline parallelism. Data parallelism is where an AI model is fully replicated and worked on independently by different processors. Model parallelism is where an AI model is subdivided and the subdivisions are worked on independently by different processors and then joined back together. Pipeline parallelism is where different processing stages over time are identified and worked on independently and then joined together.

In each of these forms of parallelism, Parallelism Client 804 tracks how the model is subdivided so that it can be joined back together. For data parallelism, if the consensus mechanism supports the amount of data, the model itself may be placed into the DC State 118a . . . n data store. In practice, this may need too much memory.

For model parallelism, Parallelism Client 804 subdivides the model and dispatches as workloads to the different User VMs 120a . . . n. Upon completion the model subdivisions are rejoined by Parallelism Client 804. In this case minimal consensus is needed. Only indications of completed processing, at most, are needed.

Pipeline parallelism is similar to model parallelism except that Parallelism Client 804 subdivides the processing of the model in stages. Here portions of the model may be placed into consensus plus flags indicating processing is complete.

While in practice, model parallelism uses the least amount of consensus and is most likely to be used, Parallelism Client 804 supports all forms of parallelism.

Turning to FIG. 9, flow chart 900 illustrates Cross Data Center Compute Aggregation. In Block 902, we start with Orchestrators 110a . . . n registered with Distributor 109 where the Orchestrators 110a . . . n have DC State 118a . . . n data stores in consensus via Consensus Communications Network 120. In Block 904 a first Orchestrator 110a reports to the Distributor 109 the amount of resources it has available including parallel processing compute resources at its Data Center 102a, and a second Orchestrator 110n reports to the Distributor 109 the amount of resources it has available including parallel processing compute resources at its Data Center 102n.

In Block 906, Distributor 109 receives a VM Request 108. Here the VM Request 108 specifies that it will accept an aggregated VM along with the attendant potential performance issues and inefficiencies. The VM Request 108 also includes a workload characterization.

In Block 908, Distributor 109 in response instantiates a Coordinating VM 802. During instantiation, it preloads Parallelism Client 804. Distributor 109 informs Parallelism Client 804 of the workload characterization from the VM Request 108. Distributor 109 also creates a User VM 120a in Data Center 102a and a User VM 120n in Data Center 102n. The Distributor 109 registers the two User VM's 120a, 120n with Parallelism Client 804.

In Block 910 User 104 sends a workload 124 to the Coordinating VM 802. The Coordinating VM receives the workload at the Parallelism Client 804 which determines whether the workload is inference, dependent inference chains, or training. If dependent inference chains, the Parallelism Client 804 builds a poset graph to store the dependent inferences while preserving order dependencies. The Parallelism Client 804 then dispatches workloads 124 to the different User VMs 102a, 102n.

In Block 912, a workload 124 is received and is performed by the first User VM 102a. Any state changes are stored to the local DC State 118a data store. Because DC State 118a data store is in consensus via Consensus Communications Network 120, the DC State 118n data store for the second User VM 102n is also updated.

In Block 914, a subsequent workload 124 is received and is performed by the second User VM 102n. In Block 916, the subsequent workload 124 is executed by the second User VM 102n. However, any dependent state changes are accessible via DC State 118n data store. In this way the results of the second User VM 102n are consistent with results. As in Block 912, the second User VM 102n also takes care to ensure that any shared state is changed in the DC State 118n data store. In this way those changes are propagated to all the other DC State 118a . . . n data stores.

In this way, we have enabled Cross Data Center Compute Aggregation at least for GenAI inference, dependent inference chains, and AI model training.

### Reporting in Fine-Grained Data Center Orchestration

Thus far, we have discussed Fine-Grained Data Center Orchestration from a systems operation's perspective. However, because the Distributor 109 and the Orchestrator 110 have a tremendous amount of visibility to all data relating to operations, they provide the basis for a comprehensive reporting platform. The following are some classes of reports enabled.

A specific class of reports relates to the economic benefits of making use of Fine-Grained Data Center Orchestration. Note that the ability to resell excess compute and to aggregate across data centers excess compute supports various business models. Reporting to show opportunity or progress can include the following: (1) Compute Supply Metrics to show how much usable or resalable compute unlocked. (2) Capacity Efficiency Metrics to show how many GPUs can be removed or repurposed. (3) Elasticity & Expansion Metrics to quantify safe overcommit and additional workload capacity. (4) Revenue & Monetization Metrics to capture financial upside generated from excess compute. (5) Economic Optimization Metrics to measure GenAI token margin improvements and reduced cost-to-serve.

Example metrics may include at least the following items. (1) Resalable Compute which measures freed capacity. This substantiates supply of aggregate excess compute for resale. (2) GPUs Saved which measures capacity reduction. This substantiates cost savings and reduction of compute footprint. (3) Overcommit/Safe Margin which measures how much a GPU may be virtualized for overcommit while minimizing the risk of resource contention. This substantiates how much revenue can be realized from overcommitting GPUs. (4) Resale Revenue Rate which measures how much revenue was in fact realized from selling excess compute. (5) Token Margin Uplift which measures the increase in the amount of GenAI tokens processed. This substantiates increased profitability for the portion of the data center being optimized.

Sometimes economic reporting relates to justifying a capital expenditure. Where KPIs are used in a simulator, comparisons can be made between configurations making use of an optimization and configurations that don't. A metric may be ROI Summary which measures projected costs savings by making use of an optimization. Compared against the cost of optimization, this substantiates whether it is cost effective to proceed with the optimization or not and over what period of time. Additional metrics to show incremental revenue generated and operating expenses saved are other examples of showing a value add.

The ability to make comparisons relies on whether how compute is measured is consistent. The data center industry is beginning to standards on the amount of GenAI language model tokens processed as the unit of measure for compute. The industry speaks of “AI Token Factories” in which capacity is measured in tokens processed which in turn enables installations and their performances to be compared regardless of hardware. We can report tokens processed and tokens processed over time such as tokens per second. These core metrics then enable the measurement of tokens per second efficiency which can be shown as a curve over time. This enables an analysis of the marginal benefit of adding additional compute and/or energy.

It follows that we can report economic core metrics of cost per token, sales price per token (which is the sale of compute to a customer), and (profit) margin per token.

This gives rise to general metrics to show an analysis of the benefits of an optimization. Example metrics would include displaying the real-time marginal energy cost and real-time revenue generation. In particular a time graph of the two should show an inverse relationship.

Overall performance metrics include a review for capacity planning. Because the Distributor 109 receives workload characterizations, it can project expected demand. Accordingly, reports showing available capacity versus expected demand can be used to project congestion likelihood.

The foregoing are just some metrics that can be used in reporting to show the value of the Distributor 109 and Orchestrator 110 deployments, the value of specific optimizations, and return on investment in general.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method to dynamically orchestrate optimization of a virtual machine within a data center, comprising:
At a distributor software module, the distributor software module configured to select a data center to provide a virtual machine as specified, receiving a plurality of registrations from a plurality of orchestrator software modules respectively, each orchestrator corresponding to a data center, the registrations comprising entry points to an application programming interface to the data center to instantiate a virtual machine, entry points to an application programming interface to communicate with the respective orchestrator, and a plurality of optimization software modules available to the orchestrator to dynamically optimize virtual machines in the orchestrator's respective data center;
receiving a request to instantiate a virtual machine, the request comprising a quantity of compute resources, a quantity of memory resources, and a quantity of parallel compute processing resources, and a characterization of the workloads to be performed on the virtual machine; and
based at least on the characterization of workloads to be performed, at the distributor selecting a data center to instantiate the requested virtual machine, and via the application programming interface provided by the data center's respective orchestrator, instantiating the requested virtual machine, and returning a logon entry point to the instantiated virtual machine in response to the received request.

2. The method of claim 1, wherein the workload characterization includes what portions of the workloads to be performed by the virtual machine are independent inferences, dependent chains of inferences, and model training.

3. The method of claim 1, wherein the workload characterization is obtained at least in part via an interactive questionnaire.

4. The method of claim 1, wherein the workload characterization is obtained at least in part via historical behavior of either the requestor or a classification of the requestor.

5. The method of claim 1, further comprising, at the selected data center's respective orchestrator:
selecting an optimization software module based at least on the workload characterization; and
applying the selected optimization software module during the initial configuration of the virtual machine.

6. The method of claim 5, wherein the selection of the optimization software module is via an artificial intelligence algorithm.

7. The method of claim 1 further comprising, at the selected data center's respective orchestrator:
dynamically receiving telemetry from the virtual machine during the operation of the virtual machine, selecting an optimization software module based at least on the dynamically received telemetry; and
applying the selected optimization software module to the virtual machine.

8. The method of claim 7 wherein the optimization software modules implement any one of energy utilization optimizations and workload compute optimizations.

9. The method of claim 7, wherein the selection of the optimization software module is via an artificial intelligence algorithm.

10. The method of claim 9 wherein the selected data center's respective orchestrator is configured to balance optimization for a plurality of objectives, and the selection of the optimization software module is based at least on the balancing of the plurality of objectives.

11. The method of claim 1, wherein either the first parallel compute virtual machine or the second parallel compute virtual machine, or both, are configured with virtual GPUs.

12. A method to aggregate parallel compute processing resources from a plurality of data centers comprising:
at a distributor software module, receiving registrations from a first orchestrator software module installed at a first data center and a second orchestrator software module installed at a second data center, each registration comprising entry points to an application programming interface to the data center to instantiate a virtual machine, and entry points to an application programming interface to communicate with the respective orchestrator;
at the distributor, receiving from the first orchestrator, a first data set quantifying available parallel compute resources at the first data center and receiving from the second orchestrator, a second data set quantifying available parallel compute resources at the second data center;
at the distributor receiving a request for a virtual machine the request comprising a quantity of parallel compute resources;
in response to the received request, the distributor instantiating a coordinating virtual machine, on the first data center instantiating a first parallel compute virtual machine comprising at least some parallel compute resources from the first data center, and on the second data center instantiating a second parallel compute virtual machine comprising at least some parallel compute resources from the second data center;
at the coordinating virtual machine, receiving a workload request and dispatching the received workload request to the first parallel compute virtual machine; and
at the coordinating virtual machine, receiving a subsequent workload request and dispatching the received subsequent workload request to the second parallel compute virtual machine.

13. The method of claim 12, wherein either the first parallel compute virtual machine or the second parallel compute virtual machine, or both, are configured with virtual GPUs.

14. The method of claim 13, wherein the first orchestrator and the second orchestrator are configured respectively with a first data store and a second data store, the first data store and the second data store are communicatively connected via a consensus communications network.

15. The method of claim 14, wherein the first parallel compute virtual machine and the second parallel compute virtual machine are both respectively configured with a generative artificial intelligence application (GenAI app), comprising at least one working buffer, and the received workload and the subsequent received workload are inference workloads;
and wherein the method further comprises:
upon executing the received workload on the first parallel compute virtual machine, uploading the respective at least one working buffer and updating the first data store;
via the consensus communications network updating the second data store with the updates to the first data store;
updating the respective working buffer of the GenAI app on the second parallel compute virtual machine; and
upon executing the received subsequent workload on the second parallel compute virtual machine, at the GenAI app, accessing the updated respective working buffer on the second parallel compute virtual machine.

16. The method of claim 15, wherein the working buffers are any one of a context buffer and a retrieval augmentation generation buffer.

17. The method of claim 14 comprising:
installing on the coordinating virtual machine at instantiation time a parallelism client software module;
at the coordinating virtual machine, receiving a workload request, determining that the workload request is a request to train an artificial intelligence model, and via the parallelism client software module subdividing at least a portion of the workload into a first training workload and a second training workload;
dispatching the first training workload to the first parallel compute virtual machine and the second training workload to the second parallel compute virtual machine;
after performing at least some of the first training workload at the first parallel compute virtual machine updating the first data store with at least some state from the performing of the at least some of the first training workload;
via the consensus communications network updating the second data store with the updates to the first data store; and
performing at least some of the second training workload at the second parallel compute virtual machine based at least on the updated second data store.

18. The method of claim 17, wherein the first data store and second data store data updates in consensus are to implement any one of data parallelism, model parallelism, and pipeline parallelism.

19. A method to dynamically orchestrate energy optimization of a virtual machine within a data center, comprising:
at a distributor software module, receiving a plurality of registrations from a plurality of orchestrator software modules respectively, each orchestrator corresponding to a data center, the registrations comprising entry points to an application programming interface to communicate with the respective orchestrator, and a plurality of optimization software modules available to the orchestrator to dynamically optimize virtual machines in the orchestrator's respective data center;
receiving at an administrative module in the distributor software module, from an orchestrator, a plurality of data center elements of the orchestrator's respective data center;
configuring the received plurality of data center elements as an intelligent distributed energy resource,
collect telemetry from the plurality of data center elements into a workload data store;
via a generative artificial intelligence application (GenAI app) with a context buffer, query the workload data store and populate the context buffer of the GenAI application with the query result; and
based at least on the collected telemetry:
generating a prompt to the GenAI app; and
receiving at least one recommendation from the GenAI app.

20. The method of claim 19, comprising, responsive to receiving the at least one recommendation from the GenAI app, automatically implementing the at least one recommendation.
